(19) United States
(12) Patent Application Publication
(10) Pub. No.: US 2008/0247842 A1
(43) Pub. Date: Oct. 9, 2008

(54) Device to be Connected to a Screw

(75) Inventors: Uwe Motsch, Rheinfelden (DE); Klaus Hullmann, Lorrach (DE); Harald Dorst, Weil am Rhein (DE)

Correspondence Address: BAKER & DANIELS LLP;111 E. WAYNE STREET, SUITE 800, FORT WAYNE, IN, 46802, US

(73) Assignee: A.RAYMOND ET CIE, Grenoble (FR)

(21) Appl. No.: 12/090,708

(22) PCT Filed: Sep. 28, 2006
(86) PCT No.: PCT/EP2006/009424

§ 371 Date: Apr. 21, 2008

(30) Foreign Application Priority Data
Oct. 21, 2005 (DE) DE102005050513.9

(51) Int. Cl. F16B 37/02; F16B 37/04

(52) U.S. Cl. 411/174

(57) ABSTRACT

The invention relates to a device to be connected to a screw. Said device comprises a plurality of connecting elements (5, 6, 7) which have respective openings (14) and which can be engaged with a thread of the screw. Said connecting elements (5, 6, 7), in a preassembly configuration, are loose pieces. Along the edge of the opening (14) of the connecting elements (5, 6, 7), a pitch section (15) of a threaded structure is configured. A connecting system (8) allows to maintain, in a final assembly configuration, the connecting elements (5, 6, 7) in a predetermined spatial relationship to each other, thereby increasing the variability of use of the device.

### RELATED APPLICATION

This application is a U.S. National Phase Patent Application based on International Application Serial No. PCT/EP2006/009424 filed Sep. 28, 2006, the disclosure of which is hereby explicitly incorporated by reference herein.

### BACKGROUND OF THE INVENTION

1. Field of the Invention

The invention relates to a device for effecting connection by means of a bolt.

2. Description of the Related Art

One known device for effecting connection by means of a bolt is known from WO98/20262. The prior device for effecting connection by means of a bolt comprises a number of connecting elements, each of which comprises an opening, and which can be brought into engagement with a thread of the bolt. The connecting elements in a pre-assembly configuration are loose pieces, a turn segment of a thread structure being formed along the edge of the opening in each connecting element. Also present is a connecting system in which the connecting elements of a final assembly configuration are held in a predetermined spatial arrangement relative to one another. The connecting elements are configured as flat plates and comprise orienting structures in the form of orienting notches that are aligned with one another when the connecting elements are arranged as intended in the final assembly configuration.

Known from U.S. Pat. No. 4,984,319 is a device in the form of a cage nut having a number of connecting elements, configured as flat plates, that can be connected to one another via side walls of a cage member that engage in marginal clearances in the connecting elements.

Known from DE 199 20 619 A1 is a device for effecting connection by means of a bolt, in the form of a stacked arrangement of connecting elements configured as flat plates and comprising projecting turn segments of a thread structure and projections for spacing apart the connecting elements.

A further device for effecting connection by means of a bolt is known from DE 33 27 055 A1. This device is configured as an anchoring body that is to be arranged in a material clearance, and comprises a number of flat connecting elements made of sheet metal, which are connected to one another via webs. Each connecting element comprises a clearance, and the clearances are aligned with one another when the connecting elements are arranged as intended in spaced parallel relation. When a bolt is tightened in the device of the generic kind, the connecting elements move sideways and come into engagement with the material.

### SUMMARY OF THE INVENTION

The present invention provides a device for effecting connection by means of a bolt that is distinguished by high stability of the stacked connecting elements prior to engagement with the connecting system.

By virtue of the inventive configuration, the mutual engagement of the orienting elements in the form of recesses and rings bring about the mutual fixation of the flat connecting elements when placed one on top of the other and their subsequent interconnection to form the thread segment.

In one advantageous embodiment of the device according to invention, the turn segment is preferably a complete thread turn. In an improvement of this embodiment, the turn segments of the plates form a continuous internal thread.

In one type of embodiment, the connecting structure in a final assembly configuration indissolubly connects the connecting elements to one another. For example, in this exemplary embodiment the connecting structure comprises weld seams or adhesive bonds.

In another type of embodiment, the connecting structure comprises a cage member, by means of which the connecting elements in a final assembly configuration are indissolubly connected to one another. In this type of embodiment, in an improvement, the connecting elements are provided at their edges with marginal clearances and the cage member comprises a baseplate and, attached to the baseplate, side walls which are disposed in the marginal clearances and which by their ends directed away from the baseplate overengage the connecting element farthest from the baseplate.

In one form thereof, the present invention provides a device for effecting connection by means of a bolt, including a number of connecting elements, each of which comprises an opening, and which are able to be brought into engagement with a thread of the bolt, the connecting elements in a pre-assembly configuration being loose pieces, a turn segment of a thread structure being formed along the edge of the opening in each connecting element, a connecting system being present in which the connecting elements, in a final assembly configuration, are held in a predetermined spatial arrangement relative to one another, and the connecting elements including flat plates and at least one orienting structure, which orienting structures are aligned with one another when the connecting elements are arranged as intended in the final assembly configuration, characterized in that mutually adapted first and second orienting elements are configured on the flat sides of each plate, the first orienting elements being recesses configured in clearances and having a diameter that is at least sectionally larger than the clearances, and the second orienting elements being rings whose dimensions accord with the corresponding dimensions of the recesses.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a preferred exemplary embodiment of the invention comprising plural connecting elements, which are mounted by means of a cage member on a fixing clamp;

FIG. 2 is a perspective view of a connecting element from the exemplary embodiment according to FIG. 1;

FIG. 3 is a section through the connecting element according to FIG. 2;

FIG. 4 is a perspective view of the cage member according to FIG. 1, with three connecting elements according to FIG. 1 and FIG. 2 arranged as intended in the cage member in a final assembly configuration;

FIG. 5 is a perspective view of a further configuration of a connecting element for a device according to the invention, viewed from the front in an insertion direction of a bolt; and

FIG. 6 is a perspective view of the configuration according to FIG. 5, viewed from the back in an insertion direction of a bolt.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

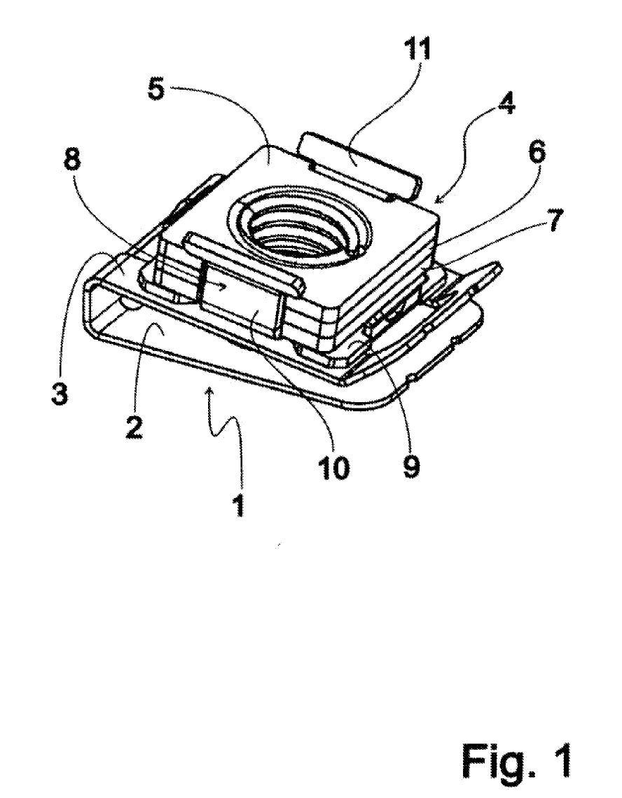

FIG. 1 is a perspective view of a fixing clamp 1 known per se, which is provided to connect two flat parts and comprises a first leg 2 and a second leg 3 that is configured with an upwardly bent insertion flap, the legs being disposed opposite each other and each being provided with an opening through which a bolt (not shown in FIG. 1) can be passed in order to fix the parts. The inventive device according to FIG. 1, which in the exemplary embodiment shown is implemented as a laminated-thread block 4, is mounted on the second leg 3.

The laminated-thread block 4 comprises, as connecting elements, a number of flat stacking plates 5, 6, 7 stamped from sheet metal, which in the pre-assembly configuration are loose and which in the exemplary embodiment according to FIG. 1 are placed one on top of the other. In the exemplary embodiment according to FIG. 1, the stacking plates 5, 6, 7 are arranged detachably from one another in a cage member 8, also stamped from sheet metal, as an example of a connecting system. The cage member 8 is configured with a baseplate 9, which is mounted on the second leg 3 of the fixing clamp 1. The cage member 8 further comprises a first side wall 10 and a second side wall 11, which serve to fix the stacking plates 5, 6, 7 in the final assembly configuration of the inventive device, i.e., the configuration illustrated in FIG. 1.

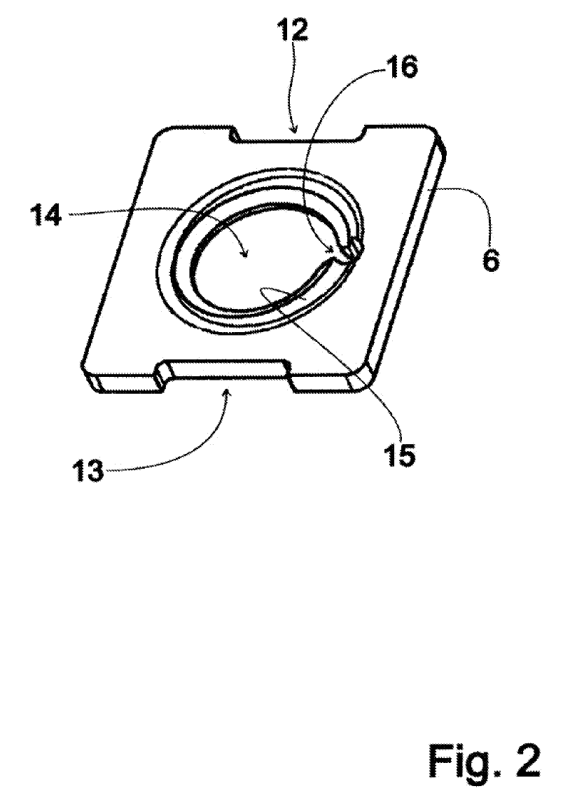

FIG. 2 is a perspective view of the middle stacking plate 6 from the exemplary embodiment according to FIG. 1, the other, outer stacking plates 5, 7 being configured identically to said middle stacking plate 6. As is clearly evident from FIG. 2, stacking plate 6 is configured as substantially square and has, on each of two opposite sides, a respective outwardly open marginal clearance 12, 13. It can further be seen from FIG. 2 that stacking plate 6 has a centrally disposed, circular opening 14, along the rim of which a circumferential partial thread turn 15 is formed. In the described exemplary embodiment, the partial thread turn 15 of each stacking plate 5, 6, 7 corresponds to a complete thread turn of an internal thread. Finally, FIG. 2 shows stacking plate 6 to be configured with an orienting notch 16, which is part of an orienting structure and extends from the wall of the opening 14 outward in the radial direction. The orienting notch 16 also serves the purpose that a bolt flank of a bolt can be applied and the bolt tightened.

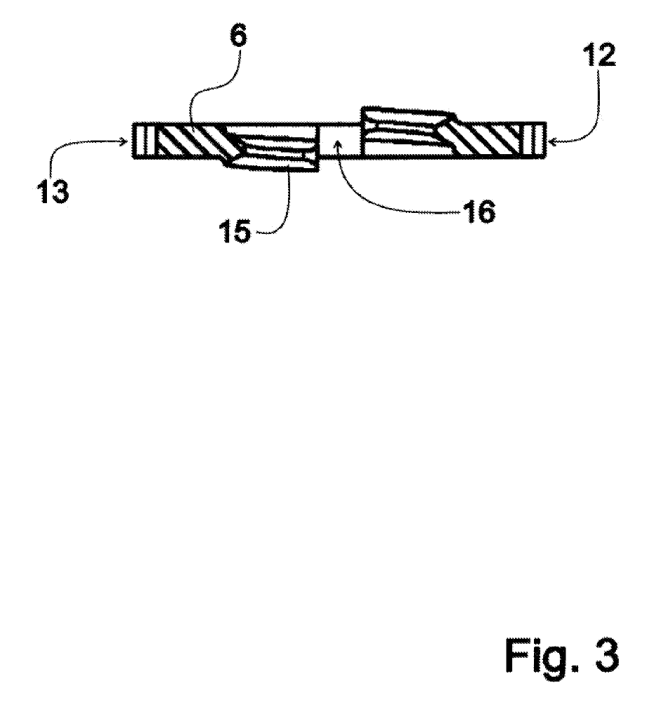

FIG. 3 shows a section through the stacking plate 6 according to FIG. 2. It is particularly clear from FIG. 3 that partial thread turn 15, which is formed by stamping, rises sectionally above the flat sides of stacking plate 6, such that a continuous internal thread is formed when the stacking plates 5, 6, 7 are placed on top of one another.

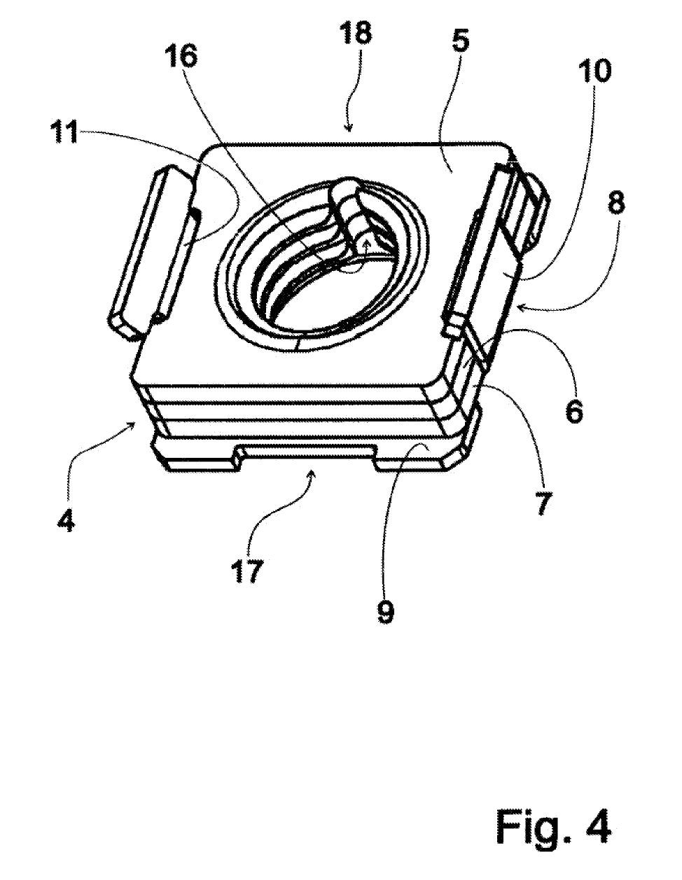

FIG. 4 shows the cage member 8 according to FIG. 1 with the stacking plates 5, 6, 7 arranged in the prescribed final assembly configuration in a fixed spatial arrangement relative to one another, i.e., in the exemplary embodiment shown, lying flat atop one another and detachably held in place. In conjunction with FIG. 2, it can be seen that the side walls 10, 11 of the cage member 8 engage in the respective marginal clearances 12, 13 of the stacking plates 5, 6, 7 and thereby fix the stacking plates 5, 6, 7. Meanwhile, the free ends of the side walls 10, 11 overengage the outer stacking plate 5 farthest from the baseplate 9 by end pieces that are bent for easy insertion of the stacking plates 5, 6, 7 and are wider than the marginal clearances 12, 13.

It can further be seen from FIG. 4 that the baseplate 9 also has mutually opposite, outwardly open marginal clearances 17, 18, which serve to secure the laminated thread block 4 by engaging with corresponding counterparts, for example configured on a fixing clamp 1.

Finally, it can be appreciated from FIG. 4 that the orienting notches 16 of the final assembly configuration are aligned with one another, thereby permitting simple random visual inspection or automatic mechanical verification of the proper orientation of the stacking plates 5, 6, 7.

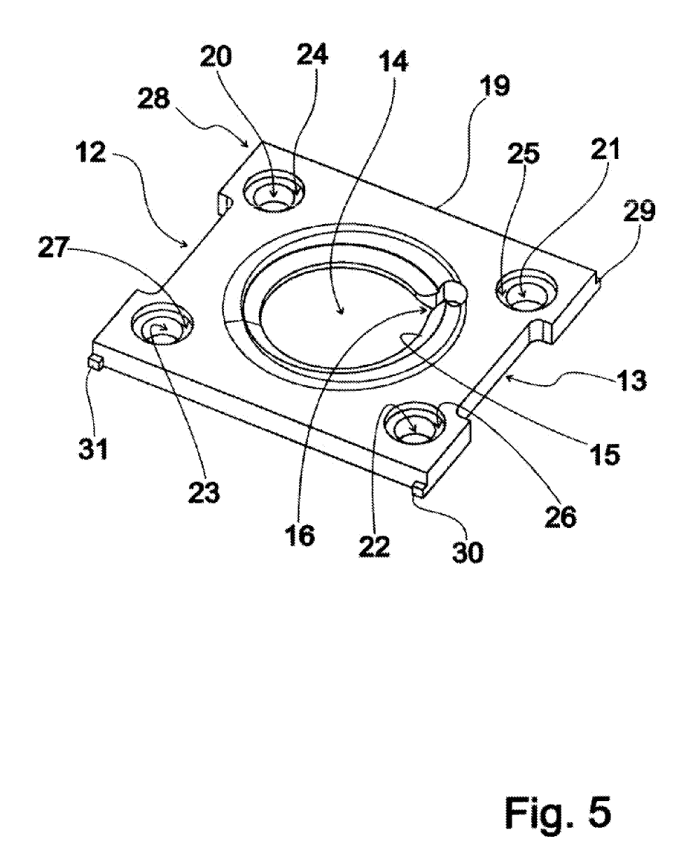

FIG. 5 is a perspective view of another configuration of a connecting element for a device according to the invention, viewed from the front in an insertion direction of a bolt. The connecting element according to FIG. 5 is also implemented as a stacking plate 19, it being noted that like features of stacking plates 5, 6, 7 described in conjunction with FIGS. 1 to 4 and stacking plate 19 according to FIG. 5 are provided with the same respective reference numerals and will not be described in more detail below. Stacking plate 19 according to FIG. 5, whose flat basic shape is rectangular, is here provided in its four corner regions with substantially cylindrical clearances 20, 21, 22, 23, each of which has a diameter on the front side, visible in the representation according to FIG. 5, that is at least sectionally larger than the diameter of the remaining section passing through the stacking plate 19, so as to form a recess 24, 25, 26, 27, as an example of first orienting elements. In the embodiment illustrated, each recess 24, 25, 26, 27 has a circular cross section and is arranged symmetrically with respect to the longitudinal axis of the associated cylindrical clearance 20, 21, 22, 23.

It can further be appreciated from FIG. 5 that formed on the uninterrupted edge faces are studs 28, 29, 30, 31 that jut out from the respective edge faces, to facilitate handling.

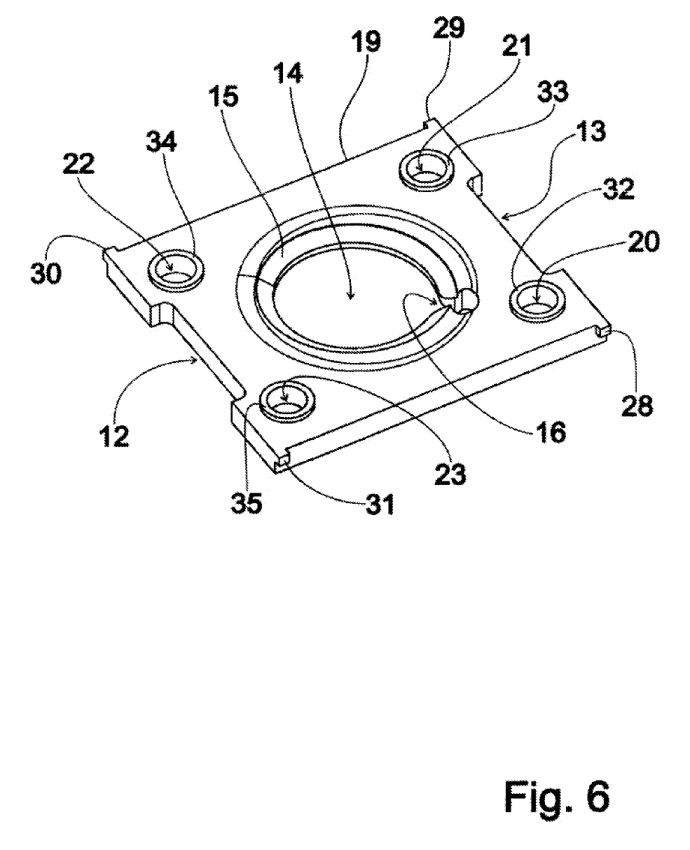

FIG. 6 is a perspective view of the stacking plate 19 according to FIG. 5, viewed from the back in the insertion direction of a bolt. It can be seen from FIG. 6 that, as an example of second orienting elements configured as complementary to the first orienting elements, a respective ring 32, 33, 34, 35 is formed on the back side at each clearance 20, 21, 22, 23, which rings are also disposed symmetrically with respect to the longitudinal axis of the clearances 20, 21, 22, 23 and whose dimensions accord with the corresponding dimensions of the recesses 24, 25, 26, 27.

The mutual engagement of the orienting elements in the form of recesses 24, 25, 26, 27 and rings 32, 33, 34, 35 in this embodiment thus brings about the mutual fixation of the stacking plates 19 when placed one on top of another and their subsequent interconnection to form the turn segment.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-8. (canceled)

9. A device for effecting a connection by means of a bolt, said device comprising:
a plurality of connecting elements formed as flat plates which, in a pre-assembly configuration are loose pieces and which, in a final assembly configuration, are held in a predetermined spatial arrangement relative to one another, each connecting element comprising:
an opening engageable with a thread of the bolt, said opening including a turn segment of a thread structure formed along an edge of said opening;
at least one orienting structure, said orienting structures aligned with one another in said final assembly configuration; and
a connecting system connecting said connecting elements in said final assembly configuration, comprising first and second orienting elements configured on respective opposite sides of each plate, said first orienting elements being recesses, said second orienting elements being rings dimensioned for engagement within said recesses.

10. The device of claim 9, wherein said turn segment is at least one complete thread turn.

11. The device of claim 10, wherein said turn segments each form a continuous internal thread.

12. The device of claim 9, wherein said connecting structure retains said connecting elements to one another in said final assembly configuration.

13. The device of claim 12, wherein said connecting structure further comprises weld seams.

14. The device of claim 12, wherein said connecting structure further comprises adhesive bonds.

15. The device of claim 9, wherein said connecting structure comprises a cage member, said cage member retaining said connecting elements in said final assembly configuration.

16. The device of claim 15, wherein said connecting elements include edges having marginal clearances, and said cage member includes a baseplate having side walls disposed within said marginal clearances, said side walls having ends directed away from said baseplate that overengage a connecting element disposed farthest from said baseplate.
